(19) United States
(12) Patent Application Publication
(10) Pub. No.: US 2025/0111188 A1
(43) Pub. Date: Apr. 3, 2025

(54) RESPONSE CONTROL DEVICE AND RESPONSE CONTROL METHOD

(71) Applicant: AVITA, Inc., Tokyo (JP)

(72) Inventors: Shogo NISHIGUCHI, Tokyo (JP); Takashi MIKAMI, Tokyo (JP); Hiroshi ISHIGURO, Tokyo (JP)

(73) Assignee: AVITA, Inc., Tokyo (JP)

(21) Appl. No.: 18/833,078

(22) PCT Filed: Jan. 16, 2024
(86) PCT No.: PCT/JP2024/000923

§ 371 Date: Jul. 25, 2024

(30) Foreign Application Priority Data
Jan. 16, 2023 (JP) 2023-004485

(51) Int. Cl. G06N 3/006

(52) U.S. Cl. CPC G06N 3/006

(57) ABSTRACT

A response control device includes a response method determination unit 14, on the basis of contents of an inquiry from a user, evaluation information relevant to a response capability of an operator, and operational status information of the operator, determining a scenario to be applied to a chatbot and an operator planned to respond, a scenario response unit 11 executing processing of the chatbot, in accordance with the scenario determined by the response method determination unit 14, and an operator connection unit 12 executing processing of attaining connection to the operator planned to respond after the execution of the processing of the chatbot, in which, in accordance with not only the operational status of the operator but also the contents of the inquiry from the user, it is possible to specify a suitable combination of the scenario and the operator planned to respond and suitably perform a handover to the operator from the chatbot.

### TECHNICAL FIELD

The present invention relates to a response control device and a response control method, and in particular, is preferable to be applied to a response system in which, after responding to an inquiry from a user with a chatbot, an operator is capable of continuously responding using information collected by the chatbot.

### BACKGROUND ART

Recently, a chatbot conducting a dialogue with a user using a voice, a text, or option presentation has been introduced into a call center system, an online customer service system in which an operator performs an online (Web) customer service through the internet, or the like. For example, a system is provided in which a response to a simple inquiry from a user is performed first by a chatbot, and then, as necessary, a response can be performed by an operator on behalf of the chatbot.

In a case where the response is performed by the operator on behalf of the chatbot, a waiting operator (an operator who is not responding to an inquiry) is searched from a plurality of operators, and the searched operator is requested to take over the response. The operator who has accepted the request takes over information collected from the user by the chatbot, and performs the continued response of the chatbot.

In the related art, in such a response system, most chatbots respond in accordance with a fixed scenario designed in advance. In this case, when the chatbot ends the execution of the fixed scenario and hands over the execution to the operator, there is a case where it is not possible to smoothly perform the handover to the operator from the chatbot, in accordance with the waiting status of the operator.

In contrast, a dialogue system is known in which scenarios with different lengths are selectively used in accordance with the operational status of an operator (any of an available state, responding, and absence) (for example, refer to PTL 1). In the dialogue system described in PTL 1, a connection time required until the operator can be connected to a next user is specified in accordance with the operational status of the operator, a question scenario in which a required time required for the execution of the question scenario falls within the connection time is specified, and a chatbot performs one or a plurality of questions on the user using the specified question scenario.

According to the system described in PTL 1, in a case where there is an operator capable of responding quickly, it is possible to quickly connect the user and the operator by decreasing the depth of a pre-question by the chatbot (or by not performing the pre-question). On the other hand, in a case where there is no operator capable of responding quickly, it is possible to cause the chatbot to perform a more in-depth question by effectively utilizing a time until the connection to the operator is attained, and decrease the number of questions from the operator after connection. As described above, by determining the mode of the pre-question, in accordance with the operational status of the operator, it is possible to reduce the total response time of the user, and improve the satisfaction level of the user.

### CITATION LIST

### Patent Literature

PTL 1: JP7097460B

### SUMMARY OF INVENTION

### Technical Problem

However, in the dialogue system described in PTL 1, the question scenario is only changed in accordance with the operational status of the operator. Accordingly, there is a problem in that the inquiry may not be necessarily handed over to a suitable operator, in accordance with the contents of the inquiry, and the inquiry may not be necessarily handed over to the operator after collecting sufficient information by the chatbot.

The invention has been made to solve the problems described above, and an object thereof is to enable a handover to an operator from a chatbot to be suitably performed in accordance with not only the operational status of the operator but also the contents of an inquiry from a user.

### Solution to Problem

In order to solve the problems described above, in the invention, in a response system in which, after responding to an inquiry from a user with a chatbot, an operator is capable of continuously responding using information collected by the chatbot, when there is the inquiry from the user, on the basis of contents of the inquiry, evaluation information relevant to a response capability of the operator, and operational status information of the operator, a response method including a scenario to be applied to the chatbot and an operator planned to respond after the response by the chatbot is determined.

### Advantageous Effects of Invention

According to the invention configured as described above, the scenario of the chatbot and the operator planned to respond are selected on the basis of the operational status and the response capability of the operator, and thus, in accordance with not only the operational status of the operator but also the contents of the inquiry from the user, it is possible to specify a suitable combination of the scenario and the operator planned to respond and suitably perform a handover to the operator from the chatbot.

### BRIEF DESCRIPTION OF DRAWINGS

FIG. 1 is a diagram illustrating an overall configuration example of a response system to which a response control device of this embodiment is applied.

FIG. 2 is a block diagram illustrating a functional configuration example of the response control device according to this embodiment.

FIG. 3 is a flowchart illustrating an operation example of the response control device according to this embodiment.

FIG. 4 is a block diagram illustrating a functional configuration example of a response control device according to a first modification example.

FIG. 5 is a flowchart illustrating an operation example of the response control device according to the first modification example.

FIG. 6 is a block diagram illustrating a functional configuration example of a response control device according to a second modification example.

FIG. 7 is a flowchart illustrating an operation example of the response control device according to the second modification example.

### DESCRIPTION OF EMBODIMENTS

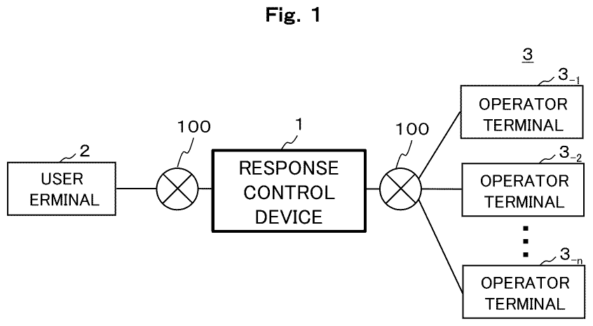

Hereinafter, one embodiment of the invention will be described on the basis of the drawings. FIG. 1 is a diagram illustrating an overall configuration example of a response system to which a response control device of this embodiment is applied. The response system of this embodiment is a system in which a response control device 1 responds to an inquiry from a user, which is sent from a user terminal 2, with a chatbot, and then, information collected by the chatbot is provided to an operator terminal 3, and the operator is capable of continuously responding using collected information. The operator terminal 3 includes a plurality of operator terminals 3₋₁, 3₋₂, . . . , and 3₋ₙ used by a plurality of operators.

The response control device 1 is a server group including one server or a plurality of servers connected to the user terminal 2 and the operator terminal 3 through a communication network 100 such as the internet or a mobile telephone network, and performs various pieces of processing required for the execution of the response to the inquiry of the user by the chatbot and the response by the operator. Here, the response control device 1, first, executes the processing of the chatbot, on the basis of a scenario, and then, is connected to any of the operator terminals 3₋ᵢ (i is any of 1 to n), and provides the information collected by the chatbot.

The user terminal 2, for example, includes a personal computer, a tablet, a smartphone, and the like. The user terminal 2 is connected to the response control device 1 through the communication network 100, and thus, the user is capable of conducting a dialogue with the chatbot using a text or a voice. In addition, the user terminal 2 is connected to the operator terminal 3₋ᵢ through the response control device 1, and thus, the user is capable of conducting a dialogue with the operator using a text, a voice, or a video.

The operator terminal 3, for example, includes a personal computer, a tablet, a smartphone, and the like. The operator terminal 3 is connected to the response control device 1 through the communication network 100, and provides information capable of specifying the operational status of the operator to the response control device 1. In addition, the operator terminal 3 is connected to the user terminal 2 through the response control device 1, and thus, the operator is capable of conducting a dialogue with the user using a text, a voice, or a video. Note that, the communication network 100 connecting between the response control device 1 and the operator terminal 3 may be a local area network (LAN).

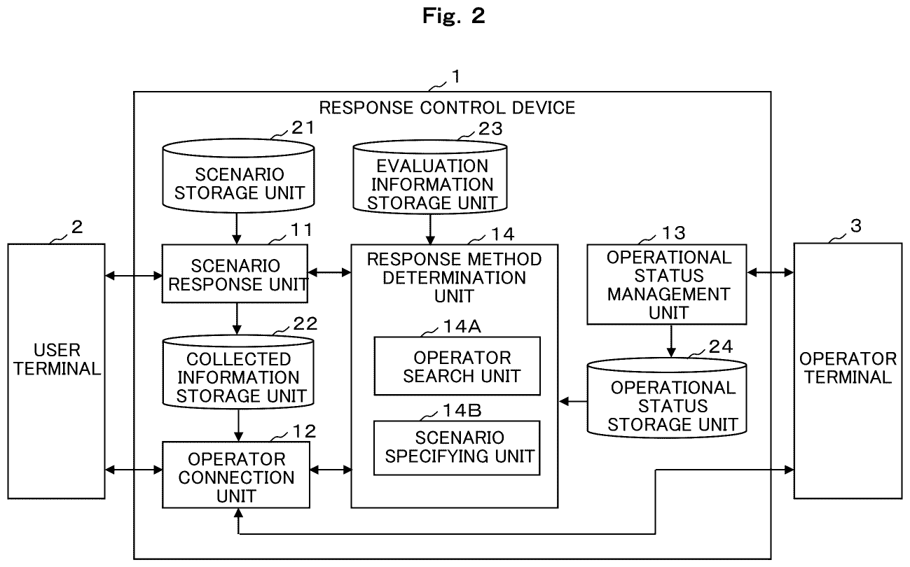

FIG. 2 is a block diagram illustrating a functional configuration example of the response control device 1 of this embodiment. As illustrated in FIG. 2, the response control device 1 of this embodiment includes a scenario response unit 11, an operator connection unit 12, an operational status management unit 13, and a response method determination unit 14, as a functional configuration. The response method determination unit 14 includes an operator search unit 14A and a scenario specifying unit 14B, as a specific functional configuration. In addition, the response control device 1 of this embodiment includes a scenario storage unit 21, a collected information storage unit 22, an evaluation information storage unit 23, and an operational status storage unit 24, as a storage medium.

The functional blocks 11 to 14 can be configured by any of hardware, a digital signal processor (DSP), and software. For example, when configured by software, the functional blocks 11 to 14 are actually configured by including CPU, RAM, ROM, and the like of a computer, and attained by operating a program stored in a storage medium such as RAM, ROM, a hard disk, or a semiconductor memory. Note that, it is not necessary that all of the functional blocks 11 to 14 are provided in one server, and the functional blocks may be provided separately in a plurality of servers.

The scenario storage unit 21 stores a plurality of scenarios applied to the chatbot. The scenario defines the contents of questions and answers executed by the chatbot until the connection to the operator is attained when there is the inquiry from the user, and includes one or more response sentences (including at least one of a greeting, a question, an answer, a statement, and the like).

Basically, the scenario is designed to collect the information from the user by the chatbot until the connection to the operator is attained. The response sentence included in the scenario is broadly divided into an in-depth response sentence for collecting information directly relevant to the contents of the inquiry from the user and a superficial response sentence for collecting information not directly relevant to the contents of the inquiry from the user. The in-depth response sentence, for example, includes a response sentence for extracting a problem that the user has and a response sentence for collecting information required to solve the problem. On the other hand, the superficial response sentence, for example, includes a response sentence for checking a field to which the contents of the inquiry belong and a response sentence for collecting formal information such as the name or the age of the user, and a desired response. The response sentence for checking the field of the inquiry, for example, is a question sentence including a plurality of field options, and includes contents for causing the user to select any of the options.

The scenario storage unit 21 stores a scenario including the in-depth response sentence (hereinafter, referred to as an in-depth scenario), a scenario including the response sentence for checking the field of the inquiry (hereinafter, referred to as a field check scenario), and a scenario including the response sentence for collecting other formal information (hereinafter, referred to as a superficial scenario). For the in-depth scenario, a plurality of scenarios are stored for each field of the inquiry. Each type of scenario is designed to collect one or more pieces of information from the user by one or more response sentences. Note that, the scenario may be designed to collect one piece of information per one response sentence, or may be designed to collect a plurality of pieces of information per one response sentence.

The scenario response unit 11 executes dialogue processing by the chatbot, on the basis of any scenario specified from the plurality of scenarios stored in the scenario storage unit 21. The scenario response unit 11 executes the field check scenario when there is the inquiry from the user, and checks the field to which the contents of the inquiry belong. After that, the scenario response unit 11 executes either an in-depth scenario corresponding to the checked field or a superficial scenario irrelevant to the field. Which scenario to execute is determined by the response method determination unit 14 (the details thereof will be described below).

The scenario response unit 11 stores the information collected from the user terminal 2 by the chatbot executing the scenario in the collected information storage unit 22. That is, the scenario response unit 11 provides one response sentence to the user terminal 2, and as a reply thereof, stores information acquired from the user terminal 2 in the collected information storage unit 22. The scenario response unit 11 sequentially stores the information acquired from the user terminal 2 in the collected information storage unit 22 by repeating the same processing for one or more response sentences included in the scenario.

After the execution of the scenario by the scenario response unit 11 is ended, the operator connection unit 12 transmits the collected information stored in the collected information storage unit 22 during the execution of the scenario to the operator terminal 3₋ᵢ, and then, connects the user terminal 2 and the operator terminal 3₋ᵢ. Which operator terminal 3₋ᵢ among the plurality of operator terminals 3₋₁, 3₋₂, . . . , and 3₋ₙ to connect to the user terminal 2 is determined by the response method determination unit 14 (the details thereof will be described below). As described above, the user of the user terminal 2 and the operator of the operator terminal 3₋ᵢ connected by the operator connection unit 12 are capable of conducting a dialogue with each other using a text, a voice, or a video.

The evaluation information storage unit 23 stores in advance evaluation information relevant to the response capability of the operator for each operator. The response capability of the operator indicates for which field of the inquiry the operator has a sufficient information collection capability. The information collection capability includes a problem extraction capability and a collection capability for the information required to solve the problem. The evaluation information is information indicating a field evaluated that the operator has a sufficient information collection capability. Such evaluation is performed by manpower, and an evaluation result thereof is stored as the evaluation information in the evaluation information storage unit 23. In a case where there are a plurality of fields evaluated that one operator has a sufficient information collection capability, information indicating the plurality of fields is stored as the evaluation information of the operator in the evaluation information storage unit 23.

The operational status storage unit 24 stores operational status information indicating the operational status of the operator relevant to a dialogue with the user. The operational status of the operator, for example, is either “responding” set when conducting a dialogue with the user or “not responding” set when not conducting a dialogue with the user. Note that, the classification of the operational status is not limited thereto. For example, the operational status may be any one of “responding” set when conducting a dialogue with the user, “post-processing” set when performing post-processing relevant to the dialogue with the user after the dialogue is ended, and “waiting” set when a response can be immediately started without conducting a dialogue with the user nor performing the post-processing.

The operational status management unit 13 sequentially updates and manages the operational status information stored in the operational status storage unit 24 for each operator. For example, the operational status management unit 13 acquires information capable of specifying the operational status of the operator from the operator terminal 3, and updates the operational status information of the operational status storage unit 24, on the basis of the acquired information. For example, a user interface for enabling the selection of the classification of the operational status by the manipulation of the operator may be displayed on the operator terminal 3, and classification information selected through the manipulation on the user interface may be transmitted to the operational status management unit 13 from the operator terminal 3.

As another example, the operational status management unit 13 may monitor the operation status of the operator connection unit 12, may recognize the operational status of the operator corresponding to the operator terminal 3 connected to the user terminal 2 by the operator connection unit 12 as “responding”, and may recognize the operational status of the operator corresponding to the operator terminal 3 not connected to the user terminal 2 as “not responding”. In addition, the operational status of the operator corresponding to the operator terminal 3 within a predetermined time since the connection with the user terminal 2 is disconnected may be recognized as “post-processing”, and the operational status of the operator corresponding to the operator terminal 3 for which a predetermined time or longer has elapsed since the connection is disconnected may be recognized as “waiting”.

When there is an inquiry for the chatbot from the user, the response method determination unit 14, on the basis of the contents of the inquiry (the field checked by the execution of the field check scenario), the evaluation information of the operator stored in the evaluation information storage unit 23, and the operational status information of the operator stored in the operational status storage unit 24, determines a response method including the scenario to be applied to the chatbot and an operator who is planned to respond after the response by the chatbot (hereinafter, referred to as an operator planned to respond).

In order to determine the response method, the response method determination unit 14 executes the processing of the operator search unit 14A and the scenario specifying unit 14B. When there is the inquiry from the user, the operator search unit 14A, on the basis of the operational status information of the operator stored in the operational status storage unit 24, searches for a response-available operator as the operator planned to respond. The response-available operator, for example, indicates an operator capable of responding preferably in a short period of time after the execution of the scenario by the chatbot is ended. For example, the operator search unit 14A searches for an operator having an operational status set as “not responding” or “waiting” as the response-available operator. Note that, such a search may be performed after the field of the inquiry is checked by the scenario response unit 11 executing the field check scenario.

Here, in a case where a plurality of operators corresponding to the above classification are searched, the operator search unit 14A selects any one operator from the plurality of operators. For example, the selection is performed randomly. On the other hand, in a case where no corresponding operator is searched, the operator search unit 14A searches for an operator having an operational status set as “responding” or “post-processing” as the operator planned to respond. In this case, after the scenario response unit 11 ends the execution of the scenario by the chatbot, the operator connection unit 12 waits until a change in the operational status of the operator planned to respond to “not responding” or “waiting” can be checked, and performs connection to the operator terminal 3₋ᵢ of the operator planned to respond.

The scenario specifying unit 14B specifies the scenario to be applied to the chatbot, on the basis of the contents of the inquiry (the field checked by the execution of the field check scenario) and the evaluation information of the operator planned to respond searched by the operator search unit 14A. Here, the scenario specifying unit 14B determines whether the operator planned to respond is capable of responding to the contents of the inquiry, on the basis of the evaluation information of the operator planned to respond, specifies the superficial scenario in a case where it is determined that the operator is capable of responding, and specifies the in-depth scenario in a case where it is determined that the operator is not capable of responding.

That is, the scenario specifying unit 14B determines whether the field of the inquiry checked by the execution of the field check scenario is coincident with the field indicated by the evaluation information of the operator planned to respond stored in the evaluation information storage unit 23. Then, in a case where the fields are coincident with each other, the scenario specifying unit 14B specifies the superficial scenario by assuming that the operator planned to respond has a capability to respond to the contents of the inquiry from the user (has a capability to collect necessary and sufficient information). Since a required time for executing the superficial scenario is shorter than a required time for executing the in-depth scenario, it is possible to minimize the dialogue with the chatbot, and attain the connection to the operator having a sufficient response capability.

Note that, in a case where the fields are coincident with each other, the execution of the superficial scenario may be skipped, and the operator terminal 3₋ᵢ of the operator planned to respond and the user terminal 2 may be connected by the operator connection unit 12. In this case, the operator of the operator terminal 3₋ᵢ also performs the collection of the formal information through the dialogue with the user, in addition to the extraction of the problem and the collection of the information required to solve the problem.

On the other hand, in a case where the fields are not coincident with each other, the scenario specifying unit 14B specifies the in-depth scenario by assuming that operator planned to respond does not have a capability to sufficiently respond to the contents of the inquiry from the user. As described above, the in-depth scenario is a scenario including the response sentence for extracting the problem that the user has, the response sentence for collecting the information required to solve the problem, and the like. Since the information collected by the execution of the in-depth scenario is provided to the operator planned to respond, an operator having a low information collection capability in the corresponding field is also capable of taking over the response from the chatbot and responding.

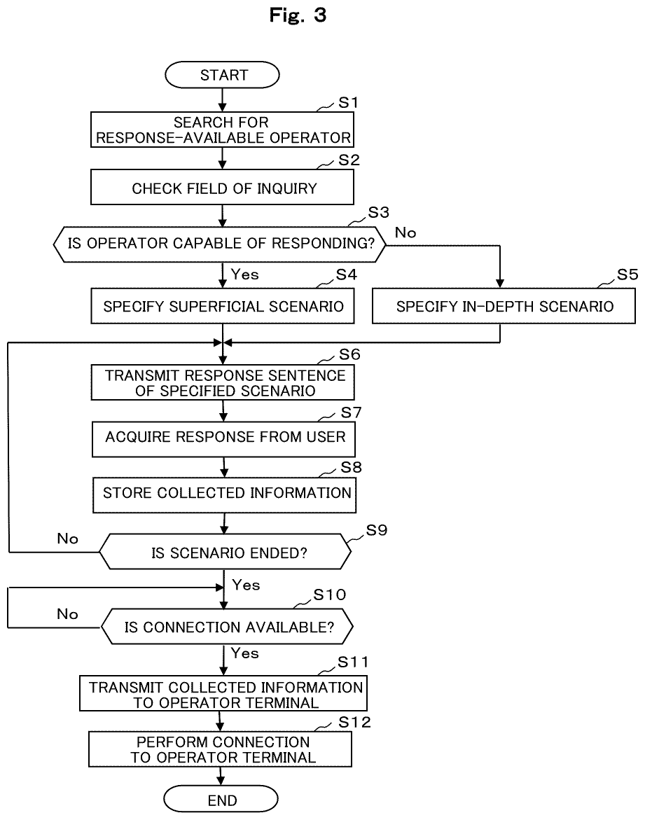

FIG. 3 is a flowchart illustrating an operation example of the response control device 1 according to this embodiment configured as described above. The flowchart illustrated in FIG. 3 is started when there is the inquiry from the user terminal 2 to the chatbot of the response control device 1.

First, the operator search unit 14A searches for the response-available operator as the operator planned to respond, on the basis of the operational status information of the operator stored in the operational status storage unit 24 (step S1). Next, the scenario response unit 11 checks the field to which the contents of the inquiry belong by executing the field check scenario (step S2). That is, the scenario response unit 11 transmits the response sentence for checking the field of the inquiry to the user terminal 2, and as a reply thereof, acquires the information indicating the field from the user terminal 2. Note that, the processing of step S1 and the processing of step S2 may be performed in the opposite order.

Next, the scenario specifying unit 14B determines whether the operator planned to respond is capable of responding to the contents of the inquiry from the user, on the basis of the field of the inquiry checked by the execution of the field check scenario, and the evaluation information of the operator planned to respond stored in the evaluation information storage unit 23 (the field evaluated to have a sufficient information collection capability) (step S3).

Here, in a case where it is determined that the operator planned to respond is capable of responding, the scenario specifying unit 14B specifies the superficial scenario (step S4). On the other hand, in a case where it is determined that the operator planned to respond is not capable of responding, the scenario specifying unit 14B specifies the in-depth scenario (step S5). In a case where the scenario is specified by the scenario specifying unit 14B, the scenario response unit 11 executes the specified scenario (steps S6 to S9).

That is, the scenario response unit 11 transmits the response sentence included in the specified scenario to the user terminal 2 (step S6), and as a reply thereof, acquires the answer information from the user terminal 2 (step S7), and stores the acquired answer information in the collected information storage unit 22 (step S8). Then, the scenario response unit 11 determines whether the transmission of all the response sentences included in the specified scenario to the user terminal 2 is ended (step S9), and in a case where there are untransmitted response sentences, the process returns to step S6.

In a case where the transmission of all the response sentences included in the specified scenario to the user terminal 2 is ended, that is, in a case where the execution of the scenario is ended, the operator connection unit 12 determines whether connection to the operator terminal 3₋ᵢ of the operator planned to respond searched in step S1 is available (step S10). Here, whether the operational status of the operator planned to respond is “not responding” or “waiting” is determined. Then, in a case where the operational status is not “not responding” or “waiting”, the determination of step S10 is repeated until the operational status is “not responding” or “waiting”.

In a case where it is determined that the connection to the operator terminal 3₋ᵢ of the operator planned to respond is available, the operator connection unit 12 transmits the collected information stored in the collected information storage unit 22 during the execution of the scenario to the operator terminal 3₋ᵢ of the operator planned to respond (step S11), and connects the user terminal 2 and the operator terminal 3₋ᵢ (step S12). Accordingly, the processing of the flowchart illustrated in FIG. 3 is ended. Note that, the connection between the user terminal 2 and the operator terminal 3₋ᵢ is disconnected by the manipulation of the user or the operator after the dialogue is ended.

Note that, an example has been described in which the scenario specified by the scenario specifying unit 14B in step S4 or step S5 is executed to the end, but the invention is not limited thereto. For example, loop processing may be formed to return to step S1 from step S9, and the search for the operator planned to respond and the specifying of the scenario may be re-executed each time when one response sentence is transmitted to the user terminal 2 to obtain an answer. Here, in the second and subsequent loop processing, the processing of step S2 will be omitted.

As described in detail above, in this embodiment, in the response system in which, after responding to the inquiry from the user with the chatbot, the operator is capable of continuously responding using the information collected by the chatbot, when there is the inquiry from the user, on the basis of the contents of the inquiry, the evaluation information relevant to the response capability of the operator, and the operational status information of the operator, the response method including the scenario to be applied to the chatbot and the operator planned to respond after the response by the chatbot is determined.

According to this embodiment configured as described above, unlike the technology of the related art in which long and short scenarios are selected on the basis of operational status of the operator, the scenario of the chatbot and the operator planned to respond are selected on the basis of the operational status and the response capability of the operator, and thus, in accordance with not only the operational status of the operator but also the contents of the inquiry from the user, it is possible to specify a suitable combination of the scenario and the operator planned to respond and suitably perform a handover to the operator from the chatbot.

### First Modification Example

In the embodiment described above, an example has been described in which even in a case where it is determined that the operator searched as the operator planned to respond by the operator search unit 14A is not capable of responding to the contents of the inquiry from the user, the operator planned to respond continues to respond on behalf of the chatbot after the execution of the in-depth scenario, but the invention is not limited thereto. For example, in a case where it is determined that the operator planned to respond is not capable of responding to the contents of the inquiry from the user, another response-available operator (who may not be capable of immediately responding in accordance with the operational status) may be re-searched as the operator planned to respond.

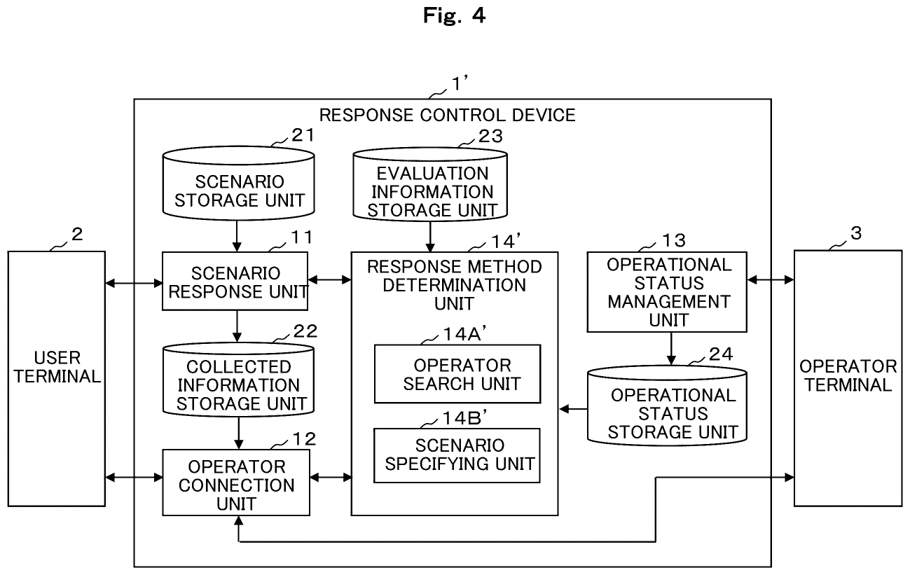

FIG. 4 is a block diagram illustrating a functional configuration example of a response control device 1′ according to a first modification example. In FIG. 4, since a constituent with the same reference numeral as that illustrated in FIG. 2 has the same function, here, the repeated description will be omitted. As illustrated in FIG. 4, the response control device 1′ according to the first modification example includes a response method determination unit 14′ instead of the response method determination unit 14. The response method determination unit 14′ includes an operator search unit 14A′ and a scenario specifying unit 14B′ instead of the operator search unit 14A and the scenario specifying unit 14B.

When there is the inquiry from the user, the operator search unit 14A′, on the basis of the operational status information of the operator stored in the operational status storage unit 24, first searches for the response-available operator as the operator planned to respond. This is the same as the operator search unit 14A described in the above embodiment. That is, the operator search unit 14A′ searches for the operator having an operational status set as “not responding” or “waiting” as the operator planned to respond.

The scenario specifying unit 14B′ determines whether the operator planned to respond is capable of responding to the contents of the inquiry, on the basis of the contents of the inquiry (the field checked by the execution of the field check scenario) and the evaluation information of the operator planned to respond searched by the operator search unit 14A′, specifies a scenario with few responses in a case where it is determined that the operator is capable of responding, and specifies a scenario with more responses in a case where it is determined that the operator is not capable of responding.

Here, the scenario with few responses is basically the superficial scenario, and in particular, a scenario with a small number of response sentences included in the scenario is specified. For example, the superficial scenario designed to collect a plurality of pieces of information per one response sentence rather than the superficial scenario designed to collect one piece of information per one response sentence is the scenario with few responses. Note that, here, even an in-depth scenario with few responses can be a specifying target. The scenario with few responses is specified in order to enable a switch from the chatbot to the operator at the earliest possible time.

On the other hand, the scenario with more responses is basically the in-depth scenario, but is not necessarily the in-depth scenario. This is because, in the first modification example, another operator capable of responding to the inquiry from the user is re-searched as the operator planned to respond, and thus, it is not essential to collect in-depth information by the chatbot. For example, in a case where it is determined that the operator planned to respond is not capable of responding to the contents of the inquiry, the scenario specified by the scenario specifying unit 14B′ may be a superficial scenario with more response sentences.

In a case where the scenario specifying unit 14B′ determines that the operator planned to respond is not capable of responding to the inquiry, the operator search unit 14A′ re-searches for the operator capable of responding to the contents of the inquiry as the operator planned to respond, on the basis of the contents of the inquiry (the field checked by the execution of the field check scenario) and the evaluation information of the operator stored in the evaluation information storage unit 23.

As described above, in this case, the scenario specifying unit 14B′ specifies the scenario with more responses. The operator planned to respond re-searched from the viewpoint of the response capability is capable of responding to the inquiry from the user, but may not be capable of responding immediately from the viewpoint of the operational status. The scenario with more responses is specified in order to gain a time until the searched operator planned to respond is in a response-available state.

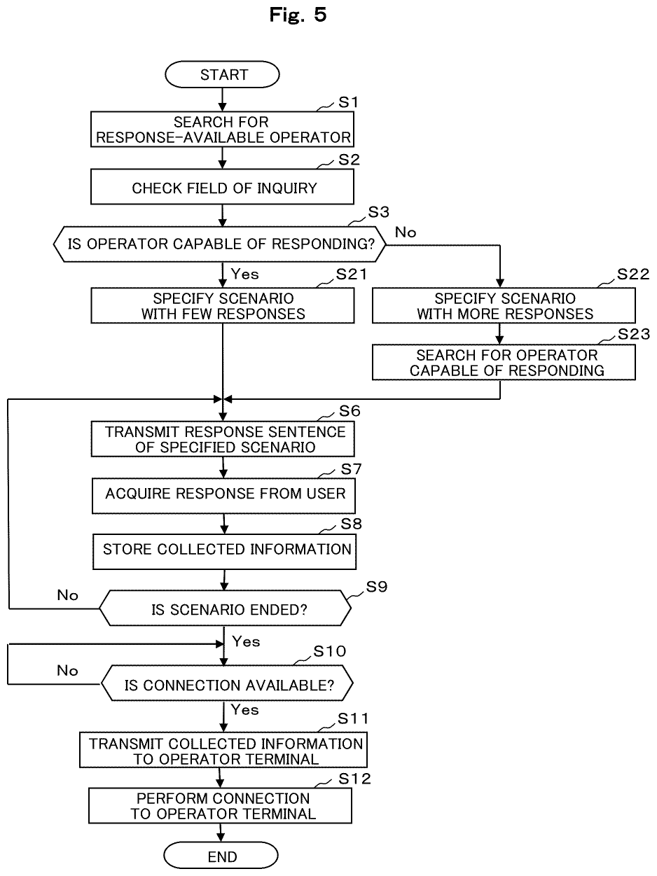

FIG. 5 is a flowchart illustrating an operation example of the response control device 1′ according to the first modification example configured as described above. The flowchart illustrated in FIG. 5 is started when there is the inquiry from the user terminal 2 to the chatbot of the response control device 1′. Note that, in FIG. 5, since processing with the same step number as the step number illustrated in FIG. 3 is the same as the processing illustrated in FIG. 3, here, the repeated description will be omitted.

In step S3 of FIG. 5, in a case where the scenario specifying unit 14B′ determines that the operator planned to respond searched in step S1 is capable of responding to the inquiry from the user, the scenario specifying unit 14B′ specifies the scenario with few responses (step S21).

On the other hand, in a case where the scenario specifying unit 14B′ determines that the operator planned to respond searched in step S1 is not capable of responding to the inquiry from the user, the scenario specifying unit 14B′ specifies the scenario with more responses (step S22). In addition, the operator search unit 14A′ re-searches for the operator capable of responding to the contents of the inquiry as the operator planned to respond, on the basis of the evaluation information of the operator stored in the evaluation information storage unit 23 (step S23).

After the processing of step S21 or step S23 is executed, the processing of steps S6 to S12 is executed, and the processing of the flowchart illustrated in FIG. 5 is ended. Note that, loop processing may be formed to return to step S1 from step S9, and the search for the operator planned to respond and the specifying of the scenario may be re-executed each time when one response sentence is transmitted to the user terminal 2 to obtain an answer.

### Second Modification Example

In the embodiment described above, an example has been described in which when there is the inquiry from the user, first, the response-available operator is searched from the viewpoint of the operational status of the operator, and then, whether the operator planned to respond is capable of responding to the contents of the inquiry from the user is determined, but the invention is not limited thereto. For example, when there is the inquiry from the user, first, the operator capable of responding to the inquiry may be searched from the viewpoint of the response capability of the operator, and then, the scenario may be specified from the viewpoint of the operational status of the searched operator planned to respond.

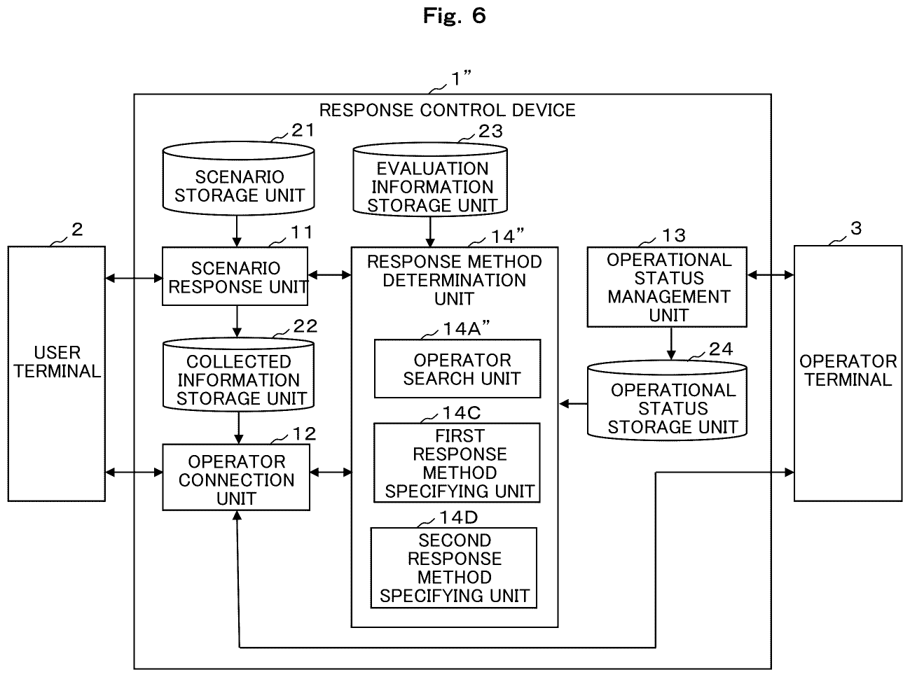

FIG. 6 is a block diagram illustrating a functional configuration example of a response control device 1″ according to a second modification example. In FIG. 6, since a constituent with the same reference numeral as that illustrated in FIG. 2 has the same function, here, the repeated description will be omitted. As illustrated in FIG. 6, the response control device 1″ according to the second modification example includes a response method determination unit 14″ instead of the response method determination unit 14. The response method determination unit 14″ includes an operator search unit 14A″, a first response method specifying unit 14C, and a second response method specifying unit 14D instead of the operator search unit 14A and the scenario specifying unit 14B.

When there is the inquiry from the user, the operator search unit 14A″, on the basis of the contents of the inquiry and the evaluation information of the operator stored in the evaluation information storage unit 23, searches for the operator capable of responding to the contents of the inquiry. That is, the operator search unit 14A″ searches for an operator whose field indicated by the evaluation information stored in the evaluation information storage unit 23 is coincident with the field of the inquiry checked by the execution of the field check scenario as the operator planned to respond. Here, in a case where a plurality of such operators are searched, the operator search unit 14A″ selects any one operator from the plurality of operators. For example, the operator is randomly selected.

In a case where the operator capable of responding is searched by the operator search unit 14A″, the first response method specifying unit 14C determines whether the response is available within a predetermined time, on the basis of the operational status information for the searched operator stored in the operational status storage unit 24, and specifies the searched operator as the operator planned to respond and specifies the scenario with few responses in a case where the response is available.

For example, in a case where the operational status of the operator is set as “not responding” or “waiting”, the first response method specifying unit 14C determines that the response is available within a predetermined time. Alternatively, the operational status management unit 13 may not only manage the operational status of each operator as the classification as described above, but also manage an estimated remaining time required until the operator is in the response-available state, and determine that the response is available in a case where the estimated remaining time is a predetermined time or shorter.

A method for managing the estimated remaining time required until the operator is in the response-available state is any method. For example, when the information collected by the chatbot is transmitted to the operator terminal 3₋ᵢ by the operator connection unit 12, a user interface for enabling the input of an estimated required time required for the response by the operator is displayed on the operator terminal 3, the estimated required time input by the operator through the manipulation to the user interface is transmitted to the operational status management unit 13 from the operator terminal 3₋ᵢ. The operator may check the collected information of the chatbot transmitted by the operator connection unit 12, and input an estimated required time required until a series of responses with respect to the user are ended. Then, the operational status management unit 13 sequentially updates the estimated remaining time by sequentially subtracting an elapsed time from the estimated required time.

As another example, a plurality of combinations of the information collected by the chatbot and a required time actually required for the response by the operator are prepared as learning data, a prediction model is created by using the learning data such that an estimated required time is output when the collected information is input. The operational status management unit 13 may acquire the estimated required time by using the prediction model, and sequentially update the estimated remaining time until the operator is in the response-available state by sequentially subtracting the elapsed time from the acquired estimated required time.

In a case where the operator capable of responding is not searched by the operator search unit 14A″, or in a case where it is determined that the operator capable of responding searched by the operator search unit 14A″ is not available for responding within a predetermined time, the second response method specifying unit 14D, on the basis of the operational status information of the operator stored in the operational status storage unit 24, searches for another response-available operator as the operator planned to respond, and specifies the in-depth scenario or the scenario with more responses. For example, the second response method specifying unit 14D specifies the in-depth scenario in a case where the operator capable of responding is not searched, and specifies the scenario with more responses in a case where it is determined that the operator capable of responding is not available for responding within a predetermined time.

In the second modification example, the operator search unit 14A″ searches for the operator planned to respond from the viewpoint of the response capability, without considering the operational status of the operator, and thus, it is not basic that no operator capable of responding is searched. However, in a case where “away from keyboard”, “on break”, and “day off”, and the like are added and managed as the classification of the operational status, and an operator with such classification is excluded from the search, it is possible that no operator capable of responding is searched.

In a case where no operator capable of responding to the contents of the inquiry is searched, an operator without a sufficient capability of responding to the contents of the inquiry responds on behalf of the chatbot. Accordingly, in such a case, the in-depth scenario is specified, and the processing of the chatbot is executed. On the other hand, in a case where the operator capable of responding to the contents of the inquiry is searched, but it is determined that the response is not available within a predetermined time, in order to gain a time until the operator is available for responding, the scenario with more responses is specified, and the processing of the chatbot is executed.

Note that, here, an example has been described in a case where the plurality of operators capable of responding to the contents of the inquiry are searched by the operator search unit 14A″, one operator is randomly selected from the plurality of operators, but the invention is not limited thereto. For example, a response-available operator within a predetermined time may be selected on the basis of the operational status information of the plurality of searched operators. Then, in a case where it is possible to select the response-available operator within a predetermined time, the first response method specifying unit 14C specifies the selected operator as the operator planned to respond, and specifies the scenario with few responses.

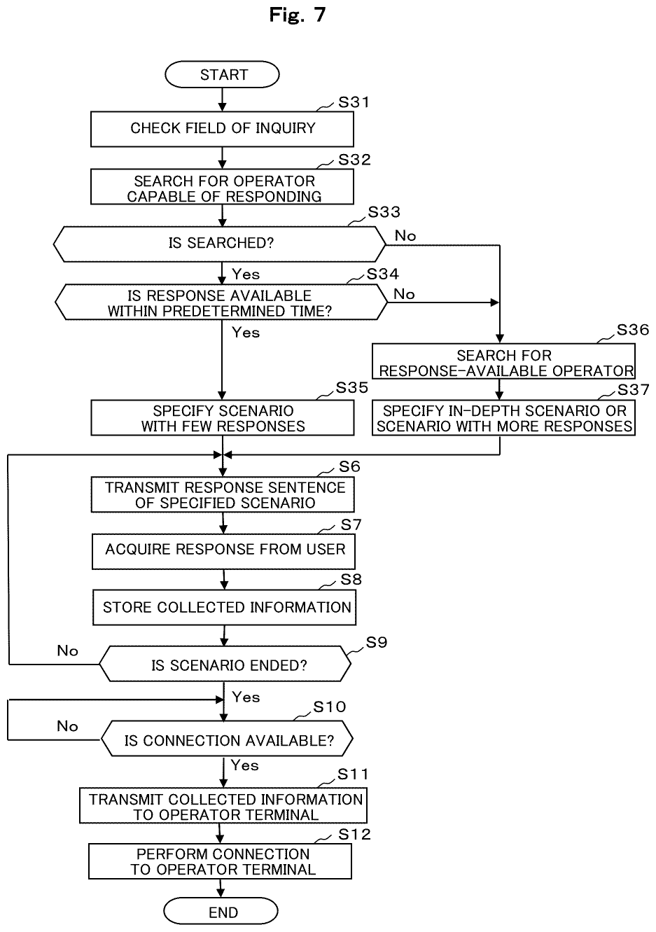

FIG. 7 is a flowchart illustrating an operation example of the response control device 1″ according to the second modification example configured as described above. The flowchart illustrated in FIG. 7 is started when there is the inquiry from the user terminal 2 to the chatbot of the response control device 1″. Note that, in FIG. 7, since processing with the same step number as the step number illustrated in FIG. 3 is the same as the processing illustrated in FIG. 3, here, the repeated description will be omitted.

First, the scenario response unit 11 checks the field to which the contents of the inquiry belong by executing the field check scenario (step S31). Next, the operator search unit 14A″ searches for the operator capable of responding to the contents of the inquiry, on the basis of the contents of the inquiry from the user (the field of the inquiry checked by the execution of the field check scenario) and the evaluation information of the operator stored in the evaluation information storage unit 23 (step S32).

Here, the first response method specifying unit 14C determines whether the operator capable of responding is searched by the operator search unit 14A″ (step S33). In a case where the operator capable of responding is searched, the first response method specifying unit 14C determines whether the response is available within a predetermined time by the searched operator, on the basis of the operational status information stored in the operational status storage unit 24 (step S34). Here, in a case where it is determined that the searched operator is available for responding within a predetermined time, the first response method specifying unit 14C specifies the operator as the operator planned to respond, and specifies the scenario with few responses (step S35).

In step S33 described above, in a case where the first response method specifying unit 14C determines that the operator capable of responding is not searched, or in step S34 described above, in a case where the first response method specifying unit 14C determines that the searched operator capable of responding is not available for responding within a predetermined time, the second response method specifying unit 14D, on the basis of the operational status information of the operator stored in the operational status storage unit 24, searches for another response-available operator as the operator planned to respond (step S36), and specifies the in-depth scenario or the scenario with more responses (step S37).

After the processing of step S35 or step S37 is executed, the processing of steps S6 to S12 is executed, and the processing of the flowchart illustrated in FIG. 7 is ended. Note that, loop processing may be formed to return to step S31 from step S9, and the search for the operator planned to respond and the specifying of the scenario may be re-executed each time when one response sentence is transmitted to the user terminal 2 to obtain an answer.

Note that, in the embodiments described above and each modification example, an example has been described in which the information indicating for which field of the inquiry the operator has a sufficient information collection capability, that is, the information indicating the field evaluated that the operator has a sufficient information collection capability is used as the evaluation information relevant to the response capability of the operator, but the invention is not limited thereto. For example, evaluation information indicating whether the operator has a high information collection capability regardless of the field may be used. For example, a result of evaluating the operator by manpower from the ability to understand what the other person says, the ability to ask questions to the other person, the amount of experience in the actual responses, the amount of knowledge, and the like may be used as the evaluation information. In the case of using such evaluation information, when there is the inquiry from the user, first executing the field check scenario can be omitted.

In addition, in the embodiments described above, the estimated remaining time required until the specified operator planned to respond is in the response-available state to the dialogue with the user may be managed, and a scenario having a required time close to the estimated remaining time may be specified.

In addition, the embodiments described above and each modification example are merely an example of the embodiment for carrying out the invention, and the technical scope of the invention should not be interpreted as being limited by the embodiments described above and each modification example. That is, the invention can be carried out in various forms without departing from the gist or main characteristics of the invention.

### REFERENCE SIGNS LIST

1, 1′, 1″: response control device
2: user terminal
3: operator terminal
11: scenario response unit
12: operator connection unit
13: operational status management unit
14, 14′, 14″: response method determination unit
14A, 14A′, 14″: operator search unit
14B, 14B′: scenario specifying unit
14C: first response method specifying unit
14D: second response method specifying unit
21: scenario storage unit
22: collected information storage unit
23: evaluation information storage unit
24: operational status storage unit

1. A response control device applied to a response system in which, after responding to an inquiry from a user with a chatbot, an operator is capable of continuously responding using information collected by the chatbot, the device characterized by comprising:
an evaluation information storage unit storing in advance evaluation information relevant to a response capability of the operator for each operator;
an operational status management unit sequentially updating and managing operational status information indicating an operational status of the operator for each operator; and
a response method determination unit, when there is the inquiry from the user, on the basis of contents of the inquiry, the evaluation information of the operator, and the operational status information of the operator, determining a response method including a scenario to be applied to the chatbot and an operator planned to respond after the response by the chatbot.

2. The response control device according to claim 1, characterized in that
the response method determination unit includes
an operator search unit, when there is the inquiry from the user, on the basis of the operational status information of the operator, searching for a response-available operator as the operator planned to respond, and
a scenario specifying unit, on the basis of the contents of the inquiry and the evaluation information of the operator planned to respond searched by the operator search unit, specifying the scenario to be applied to the chatbot.

3. The response control device according to claim 2, characterized in that
the scenario specifying unit determines whether the operator planned to respond is capable of responding to the contents of the inquiry, on the basis of the evaluation information of the operator planned to respond, specifies a superficial scenario for collecting superficial information regarding the inquiry from the user when it is determined that the operator is capable of responding, and specifies an in-depth scenario for collecting in-depth information regarding the inquiry from the user when it is determined that the operator is not capable of responding.

4. The response control device according to claim 2, characterized in that
the scenario specifying unit determines whether the operator planned to respond is capable of responding to the contents of the inquiry, on the basis of the evaluation information of the operator planned to respond, specifies a scenario with few responses when it is determined that the operator is capable of responding, and specifies a scenario with more responses when it is determined that the operator is not capable of responding, and
when the scenario specifying unit determines that the operator is not capable of responding, on the basis of the evaluation information of the operator stored by the evaluation information storage unit, the operator search unit re-searches for an operator capable of responding to the contents of the inquiry as the operator planned to respond.

5. The response control device according to claim 1, characterized in that
the response method determination unit includes
an operator search unit, when there is the inquiry from the user, on the basis of the contents of the inquiry and the evaluation information of the operator, searching for an operator capable of responding to the contents of the inquiry,
a first response method specifying unit, when the operator capable of responding is searched by the operator search unit, on the basis of the operational status information of the searched operator, determining whether a response is available within a predetermined time, specifying the searched operator as the operator planned to respond when the response is available, and specifying a scenario with few responses; and
a second response method specifying unit, when the operator capable of responding is not searched by the operator search unit or when it is determined that the operator capable of responding searched by the operator search unit is not available for responding within a predetermined time, on the basis of the operational status information of the operator, searching for another response-available operator as the operator planned to respond and specifying an in-depth scenario for collecting in-depth information regarding the inquiry from the user or a scenario with more responses.

6. A response control method for controlling a response in a response system in which, after responding to an inquiry from a user with a chatbot, an operator is capable of continuously responding using information collected by the chatbot, the method characterized by comprising:
a first step of causing a response method determination unit of a response control device, when there is the inquiry from the user, on the basis of contents of the inquiry, evaluation information relevant to a response capability of the operator, and operational status information indicating an operational status of the operator, to determine a response method including a scenario to be applied to the chatbot and an operator planned to respond after the response by the chatbot;
a second step of causing a scenario response unit of the response control device to execute processing of the chatbot, in accordance with the scenario determined by the response method determination unit; and
a third step of causing an operator connection unit of the response control device to execute processing of attaining connection to the operator determined by the response method determination unit after the execution of the processing of the chatbot by the scenario response unit.
